(19) United States
(12) Patent Application Publication
(10) Pub. No.: US 2002/0114446 A1
(43) Pub. Date: Aug. 22, 2002

(54) Method for navigating among various functions of an electronic apparatus

(76) Inventors: Jean-Francois Grimaldi, Levallois-Perret (FR); Rodolphe Guillard, Asnieres (FR); Guillaume Rebouillat, Ste Foy Les Lyons (FR)

Correspondence Address: Sughrue Mion, 2100 Pennsylvania Avenue NW, Washington, DC, 20037-3213, US

(21) Appl. No.: 10/069,445

(22) PCT Filed: Jun. 29, 2001
(86) PCT No.: PCT/FR01/02085

(30) Foreign Application Priority Data
Jun. 30, 2000 (FR) 00/08553

(51) Int. Cl. H04M 1/00; H04M 9/00

(52) U.S. Cl. 379/433.06; 379/433.01

(57) ABSTRACT

A button (13) for navigating among a plurality of functions shown on a display screen (10) of an electronic device (1) including a support (9) adapted to receive a coupling member (11) including a moving component (11a), the button being shaped so that, when it is fitted to the device, it can be dynamically coupled to the moving component (11a) and including coupling means for coupling it to guide means provided on the electronic device to confer on the button the degrees of freedom necessary for the moving component of the connecting member to function.

The present invention relates to a navigation and selection button for electronic devices such as mobile telephone type radio communication terminals, personal digital assistants, etc.

It also relates to an electronic device, in particular a telecommunication terminal, provided with this kind of navigation and selection button.

Electronic devices, and especially mobile telephones, increasingly use a menu displayed on a screen and showing functions of the device in accordance with a particular tree structure.

The terminals are provided with a navigation device in the form of one or more “navigation” keys, for example, so that the user can move around all the functions of the menu. The keys are used to display the functions and to select a required function, for example to modify the configuration of the terminal, to read received messages, etc.

Navigation devices including a first key that pivots so that it is possible to scroll through the functions by virtue of the key acting on a coupling member in two different positions are known in the art.

Other devices, such as that described in U.S. Pat. No. 5,703,947, include a thumbwheel which is rotated one way or the other to display functions successively.

However, all those prior art devices have the major drawback of necessitating an additional key for selecting a required function.

In other prior art devices the thumbwheel, in addition to rotating, has a further degree of freedom for selecting the function displayed on the screen. The user turns the thumbwheel to scroll through the functions and, when the required function is displayed, depresses the thumbwheel to select that function.

Because of its dedicated nature, that type of prior art device has a number of drawbacks.

There exist standard coupling members including a component movable in two different directions, for example in a vertical direction and in a horizontal direction, providing at least three selection possibilities (two for scrolling through the functions listed in the menu, and one for selecting a function).

In the above prior art devices, integrating the navigation key and the coupling member prevents the use of standard coupling members.

This leads to a high cost of manufacture and makes the navigation device large, which is a problem given the increasing miniaturization of radio communication terminals.

The above prior art devices also take longer to manufacture and are more complicated to manufacture.

Furthermore, integrating the navigation key into the coupling member introduces constraints that limit the aesthetic possibilities and, more importantly, because of the dedicated nature of the device, limit the possibility of adapting it to suit other electronic devices.

In this context, an object of the present invention is to alleviate the above drawbacks by proposing a device that can be fitted to existing coupling members and which is smaller and less costly than prior art devices, has improved ergonomics and aesthetics, and is easy to mass produce.

To this end, the invention provides a button for navigating among a plurality of functions shown on a display screen of an electronic device including a support adapted to receive a coupling member including a moving component, the button being shaped so that when it is fitted to the device it can be dynamically coupled to the moving component and including coupling means for coupling it to guide means provided on the electronic device to confer on the button the degrees of freedom necessary for the moving component to function, which button is characterized in that the coupling means include rotation means which co-operate with the guide means to allow rotation of the button in one direction.

The button advantageously includes means for receiving the moving component when the button is coupled to the device.

The receiving means include a housing whose inside face has a shape complementary to that of the moving component of the coupling member.

In particular, the coupling means are shaped so that they can be coupled to complementary portions of the guide means and include rotation means allowing the button to rotate relative to a face of the device on which the outside face of the button appears, with its axis parallel to said face.

For example, the rotation means include a bearing having a substantially part-cylindrical shape.

In one embodiment the coupling means include means for immobilizing the button against movement in translation in all directions parallel to the face of the device incorporating the outside face of the button.

For example, said means for immobilizing the button against movement in translation include a notch adapted to interlock with the guide means.

In one embodiment the outside face of the button has a domed portion which has a raised surface to facilitate manipulating it.

The invention also relates to an electronic device, such as a telecommunication terminal, characterized in that it is provided with a button as referred to hereinabove.

The invention also provides a system for positioning a navigation button for selecting functions of an electronic device having a front face provided with an opening allowing access to the navigation button, which is mounted to float on an integrated circuit card disposed inside the device so that it can be moved in at least one direction, characterized in that the front face includes means for holding and positioning the button so that it can move in the authorized direction or directions.

The invention will be understood better in the light of the following description, which relates to an illustrative and non-limiting embodiment of the invention and refers to the accompanying drawings, in which:

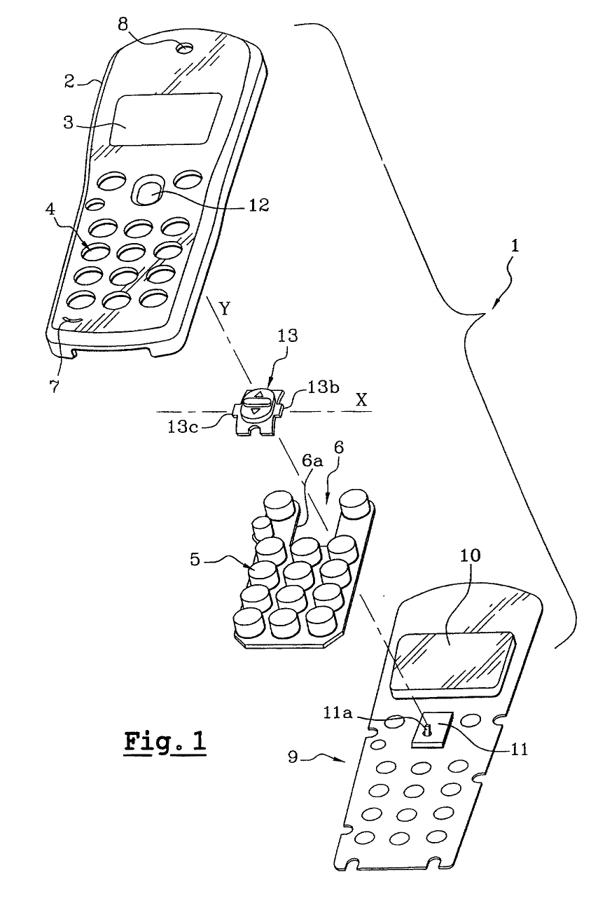

FIG. 1 is an exploded perspective view of part of an electronic device including a navigation device according to the invention;

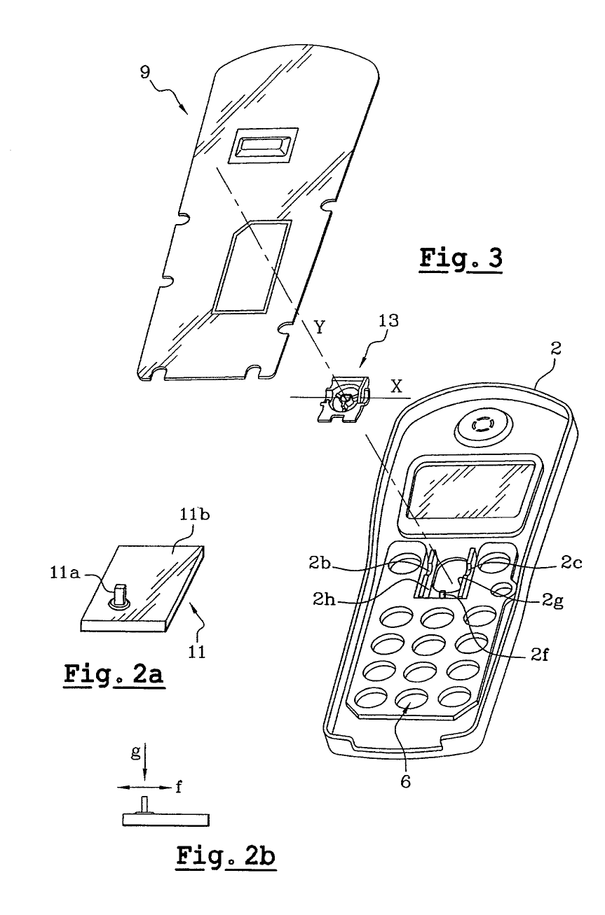

FIGS. 2a and 2b are respectively a diagrammatic perspective view and a diagrammatic side view of a standard coupling member employed by the invention;

FIG. 3 is an exploded rear perspective view of part of the electronic device incorporating the invention; and

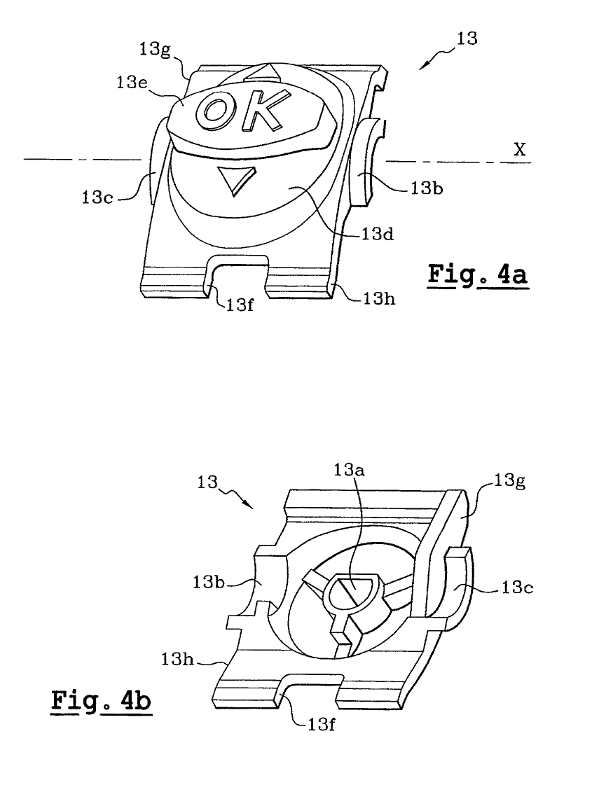

FIGS. 4a and 4b are respectively front and rear perspective views of a component of the invention.

FIG. 1 is an exploded three-quarter front perspective view of an electronic device 1 incorporating the invention.

Throughout the following description the device 1 is a radio communication terminal, for example, more commonly known as a mobile telephone.

The terminal 1 has a front face 2 (also referred to as the cover) of substantially quadrangular shape, incorporating a window 3 and openings 4 adapted to receive the keys 5 of a keypad 6.

Note that the keys 5 of the keypad 6 are joined together to form a key membrane, in a manner that is known in the art.

The front face 2 of the electronic device 1, which in itself is known in the art, also has openings 7 and 8 respectively intended for a microphone and an earpiece of the terminal 1.

The front face 2 and the keypad 6 are together associated in a manner that is known in the art with an integrated circuit card 9 including a display screen 10 of a type that is known in the art, for example a liquid crystal display screen.

A standard coupling member 11 described in more detail below with reference to FIGS. 2a and 2b is connected to and fixed to the integrated circuit card 9 in a manner that is known in the art.

An opening 12 is formed substantially at the center of the front face 2, below the window 3 for the display screen 10. The opening 12 can of course be formed elsewhere on the cover of the terminal.

The opening 12 is shaped to receive a button 13 adapted to cooperate with the standard coupling member 11. The button 13 is described in detail below with reference to FIGS. 4a and 4b.

The key membrane 6 includes an opening 6a whose shape is complementary to the outside shape of the button 13 and in which said button 13 is accommodated in the assembled electronic device 1.

An axis Y perpendicular to the plane of the front face 2 symbolizes the alignment of the opening 12, the button 13 and the standard coupling member 11.

FIGS. 2a and 2b are diagrammatic representations of the standard coupling member 11.

The coupling member 11 includes a moving component 11a projecting from its base 11b.

Because of the manner in which it is connected to the base 11b, the moving component 11a can move in at least two directions identified by arrows f and g in FIG. 2b.

The coupling member 11a provides access to three different positions, two of which are identified by the double-headed arrow f and one by the arrow g.

Accordingly, depending on how the terminal 1 is programmed, moving the moving component 11a either way in the direction indicated by the double-headed arrow f scrolls through the functions on the display screen 10, for example, and pressing the moving component 11a in the direction of the arrow g selects one of said functions from the menu.

FIG. 3 is an exploded perspective view of the rear of a portion of the terminal 1 with the key membrane 5 constituting the keypad 6 mounted on the front face 2.

The button 13 passes through the opening 6a on the front face 2 of the terminal 1 and projects slightly from said front face 2.

The button 13 includes coupling means and guide means for guiding it relative to the front face 2, in particular in the opening 12 provided in the keypad 6, once the button is fitted.

The front face 2 includes guide means for the button 13, described in detail below.

FIGS. 4a and 4b show the button 13.

The generally quadrangular button 13 includes a housing 13a (FIG. 4b) whose inside face has a shape complementary to that of the moving component 11a of the coupling member 11 so that said button 13 fits over the coupling member 11 with no play.

The button 13 also includes, on two opposite lateral sides, first and second bearings 13b and 13c of substantially part-cylindrical shape with the concave side facing toward the coupling member 11 when the button 13 is fitted.

The outside surfaces of the bearings 13b and 13c are therefore adapted to co-operate with respective guide means on the inside surface of the front face 2 of the terminal 1, in the opening 12.

The guide means consist in particular of surfaces 2b and 2c which are complementary to the outside surfaces of the bearings 13b and 13c (FIG. 3), i.e. which are part-cylindrical. The bearings 13b and 13c bear on the guide surfaces 2b and 2c and can rotate freely, simply by sliding on the respective surfaces 2b and 2c.

Thus co-operation of the surfaces 2b, 2c with the complementary surfaces of the bearings 13b and 13c provides a rotational or pivotal coupling between the fixed front face 2 (held by the user) and the button 13. The pivot axis is the axis X.

The button 13 has a domed portion 13d at its center which projects through the opening 12 in the front face 2 when the button is fitted. Said domed portion 13d has a raised surface 13e (for example a raised pattern) to facilitate manipulation of the button 13 by the user of the terminal 1.

The button 13 further includes, on a third side, a notch 13f adapted to cooperate with a complementary shape 2f on the inside of the front face 2, in the opening 12. The notch 13f is on one of the sides of the button parallel to the pivot axis X.

The notch 13f, the bearings 13b and 13c, and the lateral sides 13g and 13h on which said bearings are located immobilize the button 13 against movement in translation in all directions in a plane parallel to the front face 2, by virtue of them being in contact with the respective surfaces 2f, 2b, 2c, 2g and 2h of the front face 2.

When fitted, the button 13 can move with only two degrees of freedom: on the one hand it can rotate or pivot about the axis X in the plane of the front face 2, and on the other hand it can move in translation perpendicular to the plane of the terminal 1 (i.e. along the axis Y in FIG. 1). The rotation axis X is transverse to the longitudinal axis (not shown) of the face of the device schematically represented by the front face 2.

Movement of the button 13 in translation in a direction away from the front face 2 is opposed by a return mechanism such as a spring associated with the moving component 11a of the coupling member 11. When the user stops pressing the button 13 with their finger, the spring returns the moving component 11a to its previous position and thus pushes the button 13 along the axis Y toward the front face 2 until the bearings 13b and 13c bear again on the guide surfaces 2b and 2c.

Accordingly, when the terminal 1 is assembled, with the housing 13a in the button 13 fitted over the moving component 11a of the coupling member 11, the only possible movements of the button 13 are those of said moving component 11a.

Manipulating the navigation button 13, thanks to its guided rotation about the axis X, scrolls through the functions of the menu of the terminal 1 and the user selects the required function simply by pressing said button 13 in a direction perpendicular to the plane of the front face 2.

This simple and economic type of navigation device, which is easy to mass produce, can be applied to all kinds of electronic devices, such as personal digital assistants, landline telephones, etc.

1. A button (13) for navigating among a plurality of functions shown on a display screen (10) of an electronic device (1) including a support (9) adapted to receive a coupling member (11) including a moving component (11a), the button being shaped so that when it is fitted to the device it can be dynamically coupled to the moving component (11a) and including coupling means for coupling it to guide means provided on the electronic device to confer on the button the degrees of freedom necessary for the moving component to function, which button is characterized in that the coupling means include rotation means which co-operate with the guide means to allow rotation of the button in one direction.

2. A button according to claim 1, characterized in that it includes a housing (13a) whose inside face has a shape complementary to that of the moving component (11a) of the coupling member (11) and receives the moving component when the button is coupled to the electronic device.

3. A button according to claim 1 or claim 2, characterized in that the rotation means include a bearing (13b, 13c) having a substantially part-cylindrical shape.

4. A button according to any preceding claim, characterized in that the coupling means further include means for immobilizing the button against movement in translation in all directions parallel to the face of the device incorporating the outside face of the button.

5. A button according to the preceding claim, characterized in that said means for immobilizing the button against movement in translation include a notch (13f) adapted to interlock with an element (2b, 2c, 2f, 2g, 2h) of the guide means.

6. A button according to the preceding claim, characterized in that the outside face of the button has a domed portion (13d) which has a raised surface (13e) to facilitate manipulating it.

7. An electronic device provided with a button for navigating among a plurality of functions shown on a display screen (10) of the electronic device, characterized in that the button is a button according to any preceding claim.

8. Application of the electronic device according to the preceding claim to a telecommunication terminal.
